(19) United States
(12) Patent Application Publication
(10) Pub. No.: US 2015/0122221 A1
(43) Pub. Date: May 7, 2015

(54) TWO-WAY METERING DEVICE AND APPLICATIONS OF SAID METERING DEVICE

(71) Applicant: Valeo Systemes de Controle Moleur é, Cergy Saint Christophe (FR)

(72) Inventor: Mathieu Lallemant, Maisons-Laffitte (FR)

(21) Appl. No.: 14/401,152

(22) PCT Filed: May 13, 2013
(86) PCT No.: PCT/FR2013/051039

§ 371 Date: Nov. 14, 2014

(30) Foreign Application Priority Data
May 15, 2012 (FR) 1254437

(51) Int. Cl. F02B 37/22; F02D 21/08; F02M 25/07

(52) U.S. Cl. CPC F02B 37/225; F02M 25/07; F02D 21/08
USPC 123/337

(57) ABSTRACT

The invention relates to a double metering device for metering a fluid of an internal combustion engine, said metering device comprising a body in which are arranged a first (3) and a second (4) fluid circulation path for said fluid, in which paths first and second mobile shut-off shutters are positioned in order to meter the flow rate of fluid passing along said paths (3, 4), said metering device further comprising a motor that actuates said shutters and a drive train able to actuate the first shutter and/or the second shutter in response to actuation of said motor. According to the invention, the drive train is configured so that over a first operating range (30) it meters the flow rate passing along the first outlet path (3) by actuating the first shutter, the other shutter being held in the open position.

The field of the present invention is that of motor vehicles and more particularly that of engine fuel supply systems.

A motor vehicle internal combustion engine includes a combustion chamber, generally formed by a plurality of cylinders, in which a mixture of fuel and air is burned to generate the work of the engine.

Architectures are known in which the inlet fluid flow, including the air necessary for the operation of the engine, is divided between two pipes. One of the pipes bears a device for cooling this fluid while the other does not. These two pipes then join at the engine inlet. Thus a metering device can vary the temperature of the inlet fluid before its introduction into the cylinders according to whether more fluid is fed via the channel that passes through the cooler, called the cooled channel, or via the channel that bypasses it, called the bypass channel or non-cooled channel. The metering device therefore makes it possible to manage both the quantity and temperature of the fluid admitted into the cylinders.

In the prior art, this metering device was first produced in the form of two single metering devices that receive setpoints from the engine control computer and open their flap more or less by means of a position servocontrol actuator. They also have the function of stopping the engine in response to a specific command by placing their flap in the closed position, which cuts of the supply of air to the engine. These devices have the drawbacks of employing two components and of necessitating two control systems with the associated connectors, which significantly increases their cost and complicates the metering control system in order to guarantee that the two metering devices function simultaneously.

A first improvement was made with the creation of double metering devices that combine the two flaps and the means for controlling their position in one and the same component. One such device is described in the applicant's patent application WO 2007125205, which describes a double metering device the mechanism of which is actuated by a common motor. In that application, in normal operation, one of the flaps meters the inlet fluid, the second flap remaining closed; in a secondary mode the first flap is in the closed position while the second flap remains fully open.

Although already improving significantly on the situation, such a valve can be seen to have disadvantages. In particular its metering function is implemented in a manner that offers a low permeability to the passage of air.

The object of the present invention is to remedy these drawbacks by proposing a double metering device for metering a fluid of an internal combustion engine, said metering device including a body including a first channel and a second channel for circulation of said fluid in which are positioned first and second mobile shutter flaps for metering the flow of fluid through said channels, said metering device further including a motor for actuating said flaps and a kinematic system adapted to actuate the first flap and/or the second flap in response to actuation of said motor. Said flaps and/or said motor are mobile and notably actuated in rotation.

In accordance with the invention, the kinematic system is configured to provide, over a first range of operation, metering of the flow through the first outlet circulation channel by actuation of the first flap, the other flap being held in the open position. By “held in the open position” is meant in particular held in the fully open position.

Implementing the metering function with the other channel held open produces a valve in which the permeability during metering is increased relative to the prior art solution. Moreover, when such a valve is employed in a circuit feeding a cooled channel and a channel bypassing said cooled channel, metering is accompanied by a temperature regulation function that distributes between the two channels of the circuit the flow from the first and second circulation channels of the valve, with an advantageous level of accuracy.

In accordance with various embodiments of the invention, together or separately:
said kinematic system is further configured to provide, over a second range of operation, proportional metering on the two fluid circulation channels by simultaneous actuation of the two flaps, an increase in the flow in one of the fluid circulation channels being associated with a decrease in the flow in the other,
the kinematic system is configured to provide a constant total flow in said second range of operation,
said kinematic system is further configured to provide, over a third range of operation, metering of the flow through the second fluid circulation channel by actuation of the second flap, the first flap being held in the open position,
said kinematic system is further configured to provide, over a second range of operation, proportional metering on the two fluid circulation channels by simultaneous actuation of the two flaps, an increase in the flow in one of the fluid circulation channels being associated with a decrease in the flow in the other,
the kinematic system is further configured to produce the same flow in each of the fluid circulation channels in said second range of operation,
said kinematic system is further configured to provide, over a third range of operation, metering of the flow through the second fluid circulation channel by actuation of the second flap, the first flap being held in the closed position,
the kinematic system is configured so that continuous rotation of the actuator motor successively drives said flaps over the first range, the second range and the third range or vice versa,
said kinematic system is configured to be between said first range and said second range or between said second and said third range when the actuator motor is not activated.

Opening of the first flap may correspond to a single range of operation. In other words, the first flap may open in only one of the ranges of operation, for example in only the first range of operation or in only the second range of operation. In ranges other than that in which the first flap opens, the first flap may be immobile or close.

For example, the first flap opens in the first range of operation, closes in the second range of operation and remains open in the third range of operation.

In the context of the present application, the first flap opens when it goes from a first position corresponding to a first fluid flow section in the first channel to a second position corresponding to a second fluid flow section in the first channel, the second flow section being greater than the first flow section. The first flow section may be zero. The second flow section may be equal to the maximum flow section in the first channel, the second position then corresponding to the fully open position referred to above.

Alternatively, the first flap closes in the first range of operation, opens in the second range of operation and remains closed in the third range of operation.

In all of the foregoing, when one of the flaps moves in a range of operation, that movement in said range may be effected between two extreme positions of the flap. In other words, when a flap moves in a range of operation, that movement may be effected between the maximum open position assumed by said flap in accordance with the kinematic system and the maximum closed position assumed by said flap in accordance with the kinematic system, and vice versa. The maximum open position is for example, but not necessarily, the fully open position referred to above. The maximum closed position is for example, but not necessarily, the position in which the corresponding flap completely shuts off the channel. In this case, movement of a flap in one range of operation does not extend the movement of said flap in another range of operation.

The opening or closing of a flap may occur exclusively in one range of operation, in contrast to what is taught in the application WO 2007/089771, for example, whereby the first flap opens partly in a first range of operation during which the second flap is immobile and partly in a second range of operation in which the second flap closes.

At the end of the third range of operation, the first and/or the second channel may be open.

Said kinematic system could include a clutch element enabling one of the flaps to remain fixed, in particular in one of said first or third ranges of operation.

In accordance with one embodiment of the invention the body includes two cylindrical internal housings of circular cross section and said first and second flaps include at least one shutter part arranged in a plane inclined relative to said cylindrical housing and cooperating with the lateral wall of said housings via a circular peripheral generatrix so as to produce fluid-tight contact between said flaps and the body in at least one of their angular positions.

In accordance with different variants of this embodiment of the invention, separately or in combination:
said shutter part of the flaps is configured as a rotary disk the peripheral edge of which constitutes the generatrix of contact with said lateral wall of the cylindrical housing to provide cylinder on cylinder contact,
the shutter part of the flaps forms an angle of 45° with the axis (A) of the cylindrical housing of the body,
said flaps include a control rod that is connected to the shutter part to drive it in rotation and is disposed on the axis of said cylindrical housing passing through the center of said shutter part,
said rod and said shutter part are made in one piece,
on the side opposite the shutter part, the rod is mounted in a guide bearing secured to the body and/or connected at the outlet of the latter to said kinematic system,
in said body are formed at least one inlet and one outlet for said fluid which discharge substantially radially relative to each of said cylindrical internal housings with said flaps separating them in at least one of their angular positions,
the fluid inlet and outlet of each housing are coaxial and perpendicular to the axis of said cylindrical internal housing,
the fluid inlets and outlets are circular and the diameters thereof are less than the diameter of the disk of the shutter part cooperating via its edge with the lateral wall of the housing.

The invention also concerns a system for supplying an internal combustion engine, notably a motor vehicle internal combustion engine, with inlet gas, said system including a metering device as described above.

Said system may further include a channel including a boost air cooler and a channel bypassing said cooler, said first channel of the metering device being connected to said channel including the cooler and said second channel of the metering device being connected to said bypass channel.

The invention further concerns an exhaust gas recirculation system for an internal combustion engine, notably a motor vehicle internal combustion engine, including a metering device as described above.

Said system may further include a channel including an exhaust gas cooler and a channel bypassing said cooler, said first channel of the metering device being connected to said bypass channel and said second channel of the metering device being connected to said channel including the cooler.

The invention will be better understood and other objects, details, features and advantages thereof will become more clearly apparent during the following detailed explanatory description of various embodiments of the invention given by way of purely illustrative and nonlimiting example and with reference to the appended diagrammatic drawings.

In these drawings:

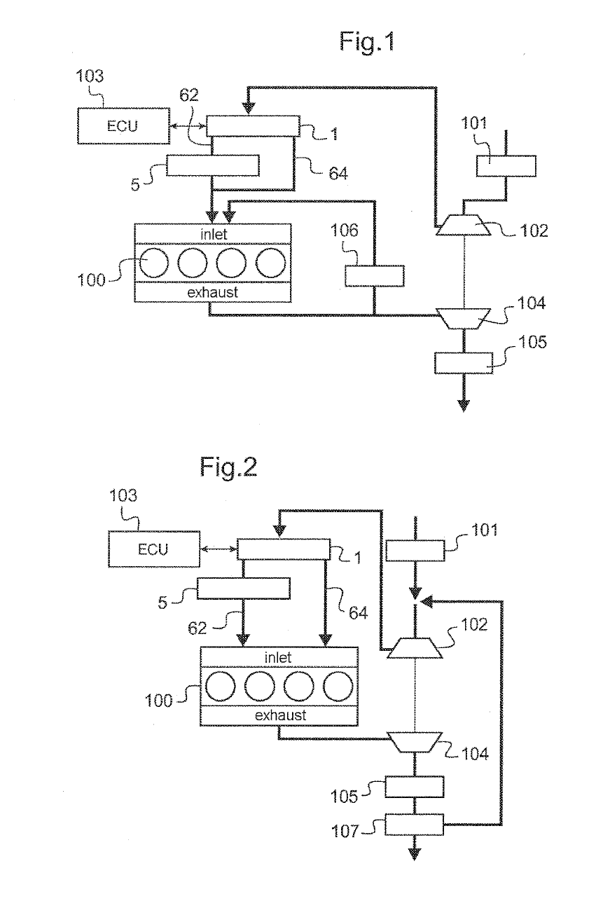

FIG. 1 is a schematic of a high-pressure fuel supply architecture for a supercharged engine,

FIG. 2 is a schematic of a low-pressure fuel supply architecture for a supercharged engine,

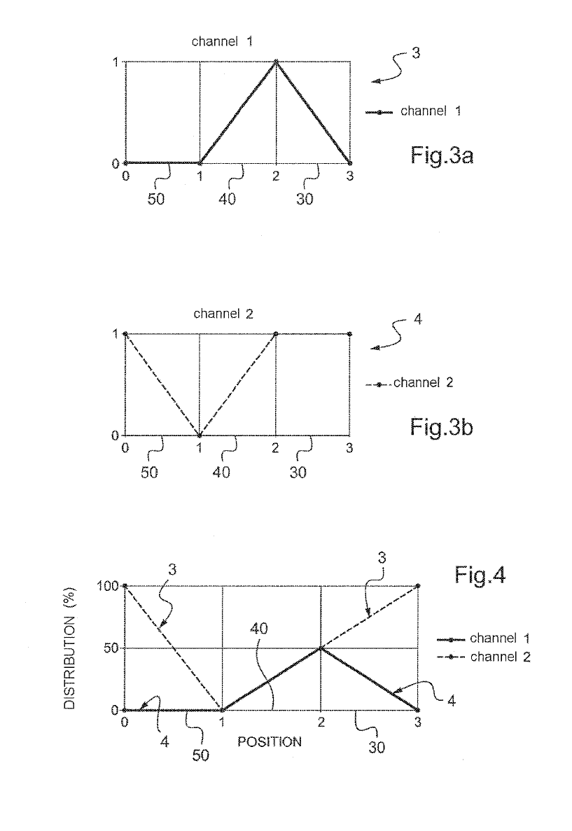

FIGS. 3a and 3b represent the evolution of the degree of opening of the first channel and the second channel, respectively, of a first embodiment of a double metering device in accordance with the invention according to the position imparted to the flaps by the motor of the double metering device,

FIG. 4 represents the distribution of the fluid in the embodiment of FIGS. 3a and 3b according to the position imparted to the flaps by the motor of the double metering device,

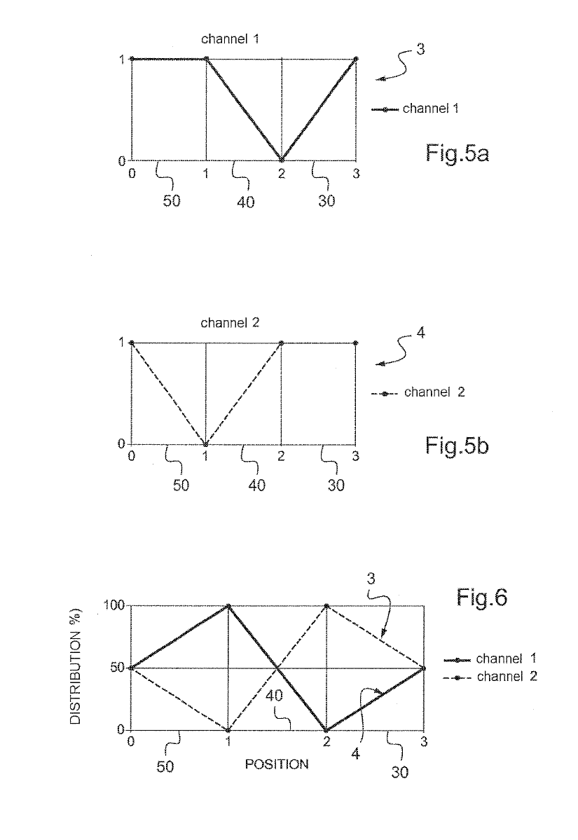

FIGS. 5a and 5b represent the evolution of the degree of opening of the first channel and the second channel, respectively, of a second embodiment of a double metering device in accordance with the invention according to the position imparted to the flaps by the motor of the double metering device,

FIG. 6 represents the distribution of the fluid in the embodiment of FIGS. 5a and 5b according to the position imparted to the flaps by the motor of the double metering device,

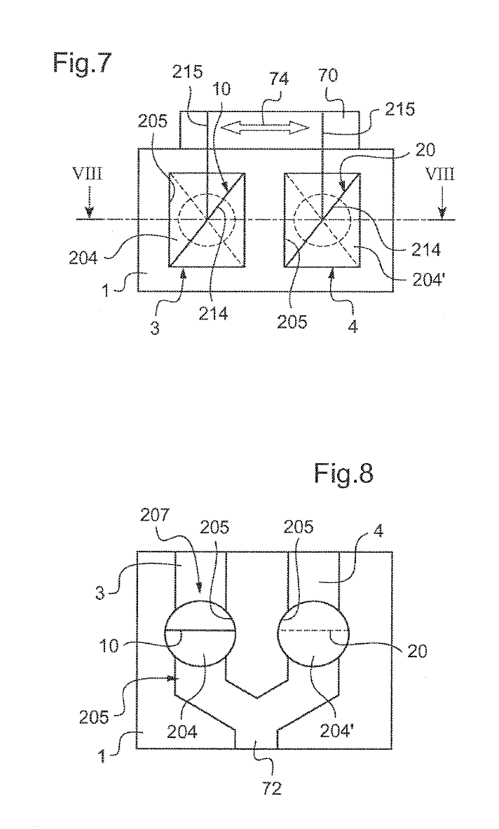

FIG. 7 is a schematic sectional view in elevation of one example of a metering device in accordance with the invention,

FIG. 8 is a schematic sectional view taken along the line VIII-VIII in FIG. 7,

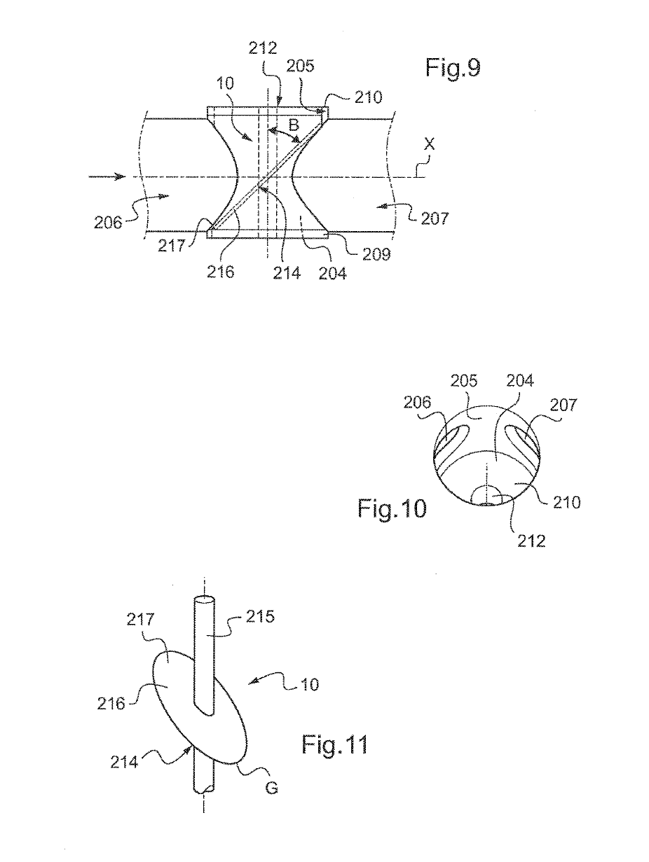

FIG. 9 is a side view showing one of the housings of the double metering device from FIG. 7,

FIG. 10 is a perspective view showing the interior of said housing,

FIG. 11 is a perspective view showing the flap in said housing.

Referring to FIG. 1, there is seen a circuit for supplying air to the cylinders 100 of a turbocharged internal combustion engine for a motor vehicle. The air, drawn in from the outside, passes through an air filter 101 and is then compressed by the compressor 102 of the turbocharger, which feeds it into a double metering device in accordance with the invention. The body 1 of the double metering device has an inlet channel through which passes air coming from the compressor and two outlet channels through which the fluid circulates downstream. It receives instructions for metering the air in these two channels from a computer 103 in the form of an electronic control unit (ECU). These instructions are executed to move first and second flaps that close said outlet channels more or less via an actuating electric motor and an appropriate kinematic system that are integrated into the body 1 of the double metering device. On one of the channels, called the cooled channel 62, connected to the first outlet channel of the metering device, there is mounted a heat exchanger or cooler 5, while the other channel, called the bypass or non-cooled channel 64, connected to the second outlet channel of the metering device, communicates directly with the inlet pipes of the engine. By varying the distribution of air between the two channels, which join on the upstream side of the inlet pipes. It is therefore possible to regulate the temperature at the engine inlet.

The burned gases leaving the cylinders of the engine are directed toward the exhaust circuit and enter the turbine 104 of the turbocharger that uses some of their residual energy to drive the corresponding compressor 102. In the conventional way, these exhaust gases then pass through a particle filter and/or a catalytic converter 105 before being ejected from the vehicle.

In the case of a high-pressure architecture, as represented in FIG. 1, some of the exhaust gases are recycled via a high-pressure valve 106 located on the upstream side of the turbine 104 in the inlet circuit downstream of where the two outlet channels join.

In the case of a low-pressure architecture, as represented in FIG. 2, the same components are employed as in a high-pressure architecture except that the recycled portion of the exhaust gases is drawn off downstream of the turbine 104 and re-injected via a low-pressure valve 107 on the upstream side of the compressor 102 of the turbocharger. The fluid that circulates in the inlet circuit is then not only air but a mixture of air and exhaust gas. The operation of the double metering device remains the same in both architectures, however.

As shown in FIGS. 3a, 3b as well as FIGS. 5a and 5b, the kinematic system is configured to provide over a first range of operation 30 metering of the flow passing through the first outlet channel 3 by actuation of the first flap, the other flap being held in the open position. Thus the invention provides a double metering device having an advantageous permeability.

In the embodiment of FIGS. 3a and 3b, the kinematic system is configured so that the degree of opening of the first channel 3 is at a maximum, the first flap being in the fully open position, at the beginning of the range 30 and decreases linearly to zero at the end of the range 30, the first flap being closed. According to the invention, the second flap in the second channel 4 is in the fully open position throughout this range 30.

The effect of such a range is represented in FIG. 4 in which it is seen that at the beginning of the range 30 the flow is shared equally between the two channels. It then evolves linearly in each of the channels to a maximum in the second channel 4 and to zero in the first channel 3 at the end of the range 30. A constant flow is therefore ensured through the valve which in the applications described hereinafter enables adjustment of temperature thanks to the distribution of the fluid between the channels 3, 4, which adjustment is all the finer in that it starts from an equal distribution at the beginning of the range 30.

In the embodiment of FIGS. 5a and 5b, the kinematic system is configured so that the degree of opening of the first channel 3 is at a minimum, the first flap being in the closed position at the beginning of the range 30 and increases linearly to finish at a maximum at the end of the range, the first flap being fully open. According to the invention, the second flap in the second channel 4 is in the fully open position throughout this range.

The effect of such a range is represented in FIG. 6 where it is seen that the flow is at a maximum in the second channel 4 at the beginning of the range 30 and is zero in the first channel 3 at the beginning of the range 30. It then evolves linearly in each of the channels 3, 4 to finish equally shared between the two channels at the end of the range 30. Once again, a constant flow is therefore ensured through the valve which in the applications described hereinafter enables adjustment of temperature thanks to the distribution of the fluid between the channels 3, 4, the adjustment being all the finer in that it finishes with an equal distribution at the end of the range 30.

Returning to the embodiment of FIGS. 3a and 3b, it is found that said kinematic system could further be configured to provide over a second range of operation 40 proportional metering on the two channels 3, 4 by simultaneous actuation of the two flaps, an increase in the flow in one of the outlet channels being associated with an increase in the flow in the other. As is apparent in FIG. 4, said kinematic system is further configured to produce the same flow in each of the channels 3, 4 in said second range of operation 40. In other words in this second range 40 the flow in each of the channels 3, 4 is the same for any position of the first and second flaps.

In accordance with the embodiment shown, the first and second flaps are closed at the beginning of the second range 40 and progressively open throughout said second range 40, with the same degree of opening, to finish in the fully open position at the end of the second range 40, which here corresponds to the beginning of said first range 30.

Said kinematic system could further be configured to provide over a third range of operation 50 metering of the flow through the second outlet channel 3 by actuation of the second flap, the other flap being held in the closed position.

In accordance with the embodiment shown, the first flap is closed and the second flap is open at the beginning of the third range 50. The second flap then progressively closes to reach the closed position at the end of the third range 50, here corresponding to the beginning of the second range 40.

Returning to the embodiment of FIGS. 5a and 5b, it is seen that said kinematic system could further be configured to achieve over a second range of operation 40 proportional metering on the two channels 3, 4 by simultaneous actuation of the two flaps, an increase in the flow in one of the outlet channels being associated with a decrease in the flow in the other. As is apparent in FIG. 4, said kinematic system is further configured to produce a constant total flow in said second range of operation 40. In other words, in this second range 40, for any position of the first and second flaps, when the flow increases in one of the channels it decreases in the other.

In accordance with the embodiment shown, at the beginning of the second range 40, the first flap is open and the second flap is closed. Then the first flap opens and the second flap progressively closes in said second range 40. At the end of the second range 40, which here corresponds to the beginning of said first range 30, the first flap ends up in the closed position and the second flap ends up in the open position.

Said kinematic system could further be configured to achieve over a third range of operation 50 metering of the flow in accordance with the invention, that is to say metering of the flow through the second channel 4 by actuation of the second flap, the other flap being held in the open position.

In accordance with the embodiment shown, the first flap and the second flap are open at the beginning of the third range 50. While the first flap remains open, the second flap then progressively closes to reach the closed position at the end of the third range 50, here corresponding to the beginning of the second range 40.

In accordance with the various embodiments shown, it is found that the kinematic system is configured so that continuous rotation of the actuator motor in a given direction acts successively on said flaps in the third, second and first ranges of operation or vice versa. In other words, the flaps go from one of these ranges to the other with no intermediate range. To be more precise, here said flaps are driven in a continuous manner over two successive ranges, namely the second range and the first range in the case of the first flap and the third range and the second range in the case of the second flap.

As expanded on hereinafter with reference to the applications described, said kinematic system is configured so as to be between said first range and said second range or between said second range and said third range when the actuator motor is not activated.

As shown in FIGS. 7 and 8, the double metering device in accordance with the invention includes, as already mentioned, a body 1 including a first circulation channel 3 for said inlet fluid and a second circulation channel 4 for said inlet fluid in which are positioned a first mobile shutter flap 10 and a second mobile shutter flap 20 for metering the fluid through said channels. Said metering device further includes a motor, not shown, for actuating said flaps 10, 20 and a kinematic system 70 adapted to actuate the first flap 10 and/or the second flap 20 in response to actuation of said motor. Said actuator motor and said flaps 10, are mobile in rotation, for example.

Said kinematic system 70, which is not shown in detail, is configured to enable implementation of the control laws referred to above by acting simultaneously on said first and second flaps 10, 20, as symbolized by the arrow 74. For example, it could include toothed or other wheels connecting a gear of the actuator motor to said first and second flaps 10, 20.

Said kinematic system could in particular include means for declutching one of the flaps 10, 20 relative to the other to provide the metering function on one of the channels, the flap of the other channel remaining fixed, in particular open. These means could be cam means configured to drive one of the flaps 10, 20 over a given angular range, corresponding in particular to said first range or said third range, while the other is not configured in this way.

Here said body 1 includes two cylindrical internal housings 204, 204′ of circular cross section, respectively accommodating said first flap 10 and said second flap 20. The latter include at least one shutter part 214 arranged in a plane inclined relative to said cylindrical housings 204, 204′ and cooperating with the lateral wall 205 of said housings via a circular peripheral generatrix to provide fluid-tight contact between said flaps 10, 20 and the body 1 in at least one angular position of said first and second flaps 10, 20.

In FIG. 7, each flap 10, 20 has been represented in two opposite and symmetrical open positions, one in solid line, the other in dashed line. In FIG. 8, the first flap 10 is represented in the closed position and the second flap 20 is represented in the open position.

For example, said valve 1 includes an inlet pipe 72 leading into the first circulation channel 3 and the second circulation channel 4 that here lead respectively to a first outlet and a second outlet of the metering device. One housing 204 is provided along the first channel 3 and the other housing 204′ is provided along the second channel 4. Said housings 204, 204′ and their corresponding flaps could be identical.

One of them has been represented in FIGS. 9 to 11, in this instance the housing 204 and said first flap 10. Said housing 204 could be regarded as similar to a bore. Into the wall of the latter lead, here radially with respect to the axis A, an inlet passage 206 and an outlet passage 207 of said first channel 3. This inlet passage 206 and this outlet passage 207 are aligned with each other, for example. Here they have a longitudinal axis X perpendicularly intersecting the axis A of the housing 204 and have identical diameters.

It is moreover seen that the cylindrical internal housing 204 is entirely closed by a transverse bottom 209 at one of its ends while at its opposite end there is a transverse cover 210. The flap 10 passes through the latter and cooperates with said kinematic system, not represented, managed by a control unit known in itself to drive said first flap 10 in rotation about the axis A in accordance with the control laws referred to above.

The inclined shutter part 214 is shaped as a rotary elliptical flap 216 centered on said axis A so that its peripheral edge 217 is in constant contact with the lateral wall 205 of the housing 204 so as to isolate the inlet passage 206 and the outlet passage 207 or to establish fluid communication between the inlet passage 206 and the outlet passage 207 with a variable flow, according to the opening angle imparted to the shutter flap 10. This peripheral edge 217 therefore constitutes a generatrix G always in fluid-tight contact with the lateral wall 205 of the housing.

By “inclined” is meant at an angle between strictly 0° and 90°. By “flap” is meant a part having two surfaces inclined relative to the axis A and connected by the peripheral edge 217. Said inclined surfaces are optionally parallel to each other. The part is thin, i.e. has a distance between said inclined surfaces very much less than the diameter of the housing 4, notably ten times less. It is a rotary elliptical disk, for example.

Geometrical considerations govern the correct functioning of the valve. Said inclined part 214 has an elliptical shape with a major axis greater than the diameter of the circular housing 204 and a minor axis substantially less than the diameter of the circular housing 204. Here the diameter of the circular housing 204 is moreover greater than the identical diameters of the fluid inlet passage 206 and the fluid outlet passage 207.

Said first flap further includes a connecting rod 215, here arranged along the axis A of the housing, so as to be centered on the inclined disk, with the angle B between the inclined plane of the disk and the axis A here equal to 45°. To obtain constant contact with the lateral wall 205 of the housing, the major axis of the disk 216 is therefore substantially equal to the diameter of the housing multiplied by √2. This contact may be defined as being a cylinder/cylinder contact between the circular section wall 205 of the housing 4 and the generatrix G corresponding to the peripheral edge 217 of the inclined disk 216 that is circular when projected onto a plane perpendicular to the rotation axis of the flap. The minor axis of the flap 216 could be substantially greater than the diameter of the fluid inlet passage 206 and the fluid outlet passage 207.

It is seen that mounting the flap 10 in the housing 204 of the body of the valve does not necessitate any fastidious adjustment operation, all that is required to center the disk 216 relative to the fluid passages being to bring the flap 10 into axial abutment in the housing.

One end of the rod 215 is associated with the disk 216, to which it is assembled or over which it is molded, or is formed with the disk, so as to obtain one-piece shutter means 3. For example, the disk 216 may be made of plastic and the rod 215 made of metal, or vice versa, or both may be made of plastic material or metal, depending on the one-piece or composite implementation chosen. The other end of the rod passes through the axial hole 212 in the body 1 to be connected to said kinematic system. Said clutch means enable deactivation of the driving of the rod 215 of one of the flaps 10, 20 during actuation of the other flap as and when required.

Such a valve consequently achieves fluid-tightness in both closing directions through the fit of the inclined disk in the circular housing (cylinder-cylinder contact). Said disk may equally be driven over more than 360°. By virtue of its symmetry, it may further be mounted either way round without any polarizing means in the body of the valve. Furthermore, as the edge of the disk moves linearly on the cylindrical wall, this enables prevention of soiling between the disk and the wall and self-cleaning of the valve, which is beneficial when the latter is used for the circulation of recirculated exhaust gases.

Other types of flap may of course be envisaged, such as spherical flaps or butterfly-type flaps.

Referring again to FIGS. 1 and 2, it is seen that the invention also concerns a device for supplying inlet gas to an internal combustion engine, notably a motor vehicle internal combustion engine.

The control law implemented in this application corresponds to that illustrated by FIGS. 5a, 5b and 6, for example. Said rest position, corresponding to absence of activation of the motor for actuating the flaps of the metering device, could be the transition position between the second range and the third range, i.e. with the flap open in the first channel 3 of the metering device, corresponding to the cooled channel 62 of the circuit, and the flap closed in the second channel 4 of the metering device, corresponding to the non-cooled channel 64 of the circuit.

Said third range 50 is traced out by rotation of the second flap from said rest position in a first direction, the first flap remaining fixed by virtue of declutching said kinematic system. There is then a change from a low temperature to an intermediate temperature by metering in the second channel 4.

The second range 40 is traced out by rotation of the second flap in the other direction and by rotation of the first flap as far as the beginning of the first range 30. The first flap closes while the other flap opens and there is then a change from a low temperature to a high temperature by effecting proportional metering in the two channels.

The first range 30 is traced out by continuing the rotation of the first flap, in the same direction, the second flap remaining fixed by virtue of declutching said kinematic system. There is then a change from a high temperature to an intermediate temperature by metering in the first channel 3.

This being the case, the invention could equally well concern a system for recirculation of exhaust gases of an internal combustion engine, notably a motor vehicle internal combustion engine, including a metering device as described above.

Said system further includes a channel including an exhaust gas cooler and a channel bypassing said cooler, said first channel of the metering device being connected to said bypass channel and said second channel of the metering device being connected to said channel including the cooler.

The control law implemented in this application corresponds to that illustrated by FIGS. 3a, 3b and 4, for example. Said rest position could be the transition position between the second range and the third, both flaps then being closed.

Said third range 50 is traced out by rotation of the second flap from said rest position in a first direction, the first flap remaining fixed by virtue of declutching said kinematic system. As a result the cooled channel is opened and the fully cooled recirculated exhaust gases are metered.

The second range 40 is traced out by rotation of the second flap in the other direction and by rotation of the first flap as far as the beginning of the first range 30. The two flaps then open simultaneously and there is a change from a low temperature to a high temperature by proportional metering in the two channels, which makes it possible to achieve EGR metering at an intermediate temperature.

The first range 30 is traced out by continuing the rotation of the first flap, in the same direction, the second flap remaining fixed by virtue of declutching said kinematic system. The first channel or non-cooled channel 3 is therefore metered, which corresponds to cooling of the EGR from said intermediate temperature.

1. A double metering device for metering a fluid of an internal combustion engine, said metering device comprising:
a body comprising a first channel and a second channel for circulation of said fluid, in which are positioned a first mobile shutter flap and a second mobile shutter flap for metering the flow of fluid through said channels;
a motor for actuating said flaps; and
a kinematic system configured to actuate the first flap and/or the second flap in response to actuation of said motor, the kinematic system being configured to provide a plurality of ranges of operation comprising a first range of operation corresponding to metering of the flow through the first circulation channel by actuation of the first flap, the second flap being held in the open position, the first flap opening in only one of the plurality of ranges of operation.

2. The metering device as claimed in claim 1, wherein said kinematic system is further configured to provide, over a second range of operation, proportional metering on the two fluid circulation channels by simultaneous actuation of the two flaps, an increase in the flow in one of the fluid circulation channels being associated with a decrease in the flow in the other.

3. The metering device as claimed in claim 2, wherein the kinematic system is configured to provide a constant total flow in said second range of operation.

4. The metering device as claimed in claim 2, wherein said kinematic system is further configured to provide, over a third range of operation, metering of the flow through the second fluid circulation channel by actuation of the second flap, the first flap being held in the open position.

5. The metering device as claimed in claim 1, wherein said kinematic system is further configured to provide, over a second range of operation, proportional metering on the two fluid circulation channels by simultaneous actuation of the two flaps, an increase in the flow in one of the fluid circulation channels being associated with an increase in the flow in the other.

6. The metering device as claimed in claim 5, wherein the kinematic system is further configured to produce the same flow in each of the fluid circulation channels in said second range of operation.

7. The metering device as claimed in claim 5, wherein said kinematic system is further configured to provide, over a third range of operation, metering of the flow through the second fluid circulation channel by actuation of the second flap, the first flap being held in the closed position.

8. The double metering device as claimed in claim 4, wherein the kinematic system is configured so that continuous rotation of the actuator motor successively drives said flaps over the first range, the second range and the third range or vice versa.

9. The metering device as claimed in claim 4, wherein said kinematic system is configured to be between said first range and said second range or between said second and said third range when the actuator motor is not activated.

10. The metering device as claimed in claim 4, wherein a single range of operation corresponds to opening of the first flap.

11. The metering device as claimed in claim 6, wherein said kinematic system includes a clutch element enabling one of the flaps to be left fixed in one of said plurality of ranges of operation.

12. The double metering device as claimed in claim 11, wherein the body includes two cylindrical internal housings of circular cross section and said first and second flaps comprise at least one shutter part arranged in a plane inclined relative to said cylindrical housings and cooperating with the lateral wall of said housings via a circular peripheral generatrix so as to produce fluid-tight contact between said flaps and the body.

13. A system for recirculating exhaust gases of a motor vehicle internal combustion engine, said system including a metering device as claimed in claim 1.

14. The system as claimed in claim 13, further comprising a channel including an exhaust gas cooler and a channel bypassing said cooler, said first fluid circulation channel of the metering device being connected to said bypass channel and said second fluid circulation channel of the metering device being connected to said channel including the cooler.

15. A system for feeding a motor vehicle internal combustion engine, with inlet gas, said system including a metering device as claimed in claim 1.

16. The system as claimed in claim 15, further comprising a channel including a boost air cooler and a channel bypassing said cooler, said first fluid circulation channel of the metering device being connected to said channel including the cooler and said second fluid circulation channel of the metering device being connected to said bypass channel.
